(19) United States
(12) Patent Application Publication
(10) Pub. No.: US 2011/0055981 A1
(43) Pub. Date: Mar. 3, 2011

(54) Device for Positioning a Moveable Object of Submicron Scale

(75) Inventors: Alina Voda, Grenoble (FR); Gildas Besancon, Grenoble (FR); Sylvain Blanvillain, Veretz (FR)

(73) Assignees: UNIVERSITE JOSEPH FOURIER, Grenoble Cedex 9 (FR); INSTITUT POLYTECHNIQUE DE GRENOBLE, Grenoble (FR)

(21) Appl. No.: 12/935,063

(22) PCT Filed: Mar. 25, 2009
(86) PCT No.: PCT/FR09/50519

§ 371 Date: Nov. 9, 2010

(30) Foreign Application Priority Data
Mar. 28, 2008 (FR) 0852007

(51) Int. Cl. G01Q 10/00

(52) U.S. Cl. 850/1

(57) ABSTRACT

The instant disclosure describes a device for positioning a moveable object which can be moved over a distance of the order of 1 nanometer in a time of 1 microsecond or less, comprising: a microtip; first piezoelectric positioning, polarization, detection and control means for moving the microtip relative to the object and bringing it to a distance of the order of 1 nanometer from the object in order to make a tunnel current flow between the microtip and the object, for measuring the tunnel current and for slaving, depending on the measured tunnel current, the distance between the microtip and the object to a constant value (d_{ref}); and second positioning and control means which are capacitively coupled to the object so as to oppose an attractive force between the object and the microtip depending on the measured tunnel current, the second means being tied to a reference plane.

### FIELD OF THE INVENTION

The present invention aims at setting with an accuracy on the order of one nanometer, or even of one tenth of a nanometer, the position of an object of submicron scale capable of moving very fast.

### DISCUSSION OF PRIOR ART

To determine the properties and the position of a very small object, or to determine very small surface variations of an object, atomic force microscopes and scanning tunneling microscopes are currently known.

A scanning tunneling microscope comprises a microtip capable of being brought close enough to an object for a tunnel current to be able to flow between the microtip and the object when an appropriate potential difference is applied between the microtip and the object and the latter is at a reference potential.

A number of variations of such atomic force and scanning tunneling microscopes are known. In particular PCT patent application WO2007135345 by M. Hrouzek, A. Voda, J. Chevrier, G. Besançon, and F. Comin describes an atomic-force microscope wherein the microtip is arranged on an oscillating arm with controlled oscillations. The object is mounted on a piezoelectric element and the oscillating arm of the microtip is controlled, for example, by capacitive effect. In this patent application, it is considered that the object is fixed but that its position can be adjusted by an action on the piezoelectric element supporting it.

An advantage of scanning tunneling microscopy devices is that they enable to detect very small variations of the distance, and thus of the position, below one nanometer.

Another advantage of scanning tunneling microscopy devices is that they may be achieved in highly miniaturized form. Indeed, they only use a measurement of the scanning tunneling current to measure the distance from the tip to the object.

However, a disadvantage of scanning tunneling microscopy devices is that they have a limited bandwidth and do not enable to analyze objects capable of moving fast.

### SUMMARY

An object of an embodiment of the present invention is to use a scanning tunneling microtip measurement system to determine the position and thus, possibly, to control the position of a mobile object of submicron scale having a very low inertia. “Low inertia” means that the mobile object is capable of moving over distances ranging from approximately one nanometer to a few tens of nanometers within times shorter than one microsecond.

As they have tried to use a microtip scanning tunneling microscopy system on objects having such a low inertia, the inventors have found that it was not possible to use conventional systems for regulating the distance from the microtip to the object. Indeed, when the microtip is brought close to the object to start the tunneling, an attractive force appears between the microtip and the object. This attraction increases proportionally to an integral power of the distance between the object and the microtip. If the object has an extremely low inertia, it is not possible to remove the microtip fast enough with a piezoelectric device and this object sticks to the microtip, making any measurement impossible. This attraction and sticking phenomenon is often designated in the art as the “pull-in”.

To solve this problem, the inventors provide forming a double servo-control loop:
a first conventional loop between the microtip and the object to regulate the distance from the microtip to the object according to the measured current, and
a second loop also driven by the measured tunnel current, to exert a capacitive force between the object and a reference plane, this capacitive force acting in a direction opposite to that of the attractive force between the microtip and the object.

Due to this double loop, a very fast control is obtained and, as soon as an attraction occurs between the microtip and the object, the object can be drawn away from the microtip so that it does not stick to it.

More specifically, an embodiment of the present invention provides a device for positioning a moveable object capable of moving over a distance on the order of one nanometer within a time shorter than or equal to one microsecond comprising a microtip; first piezoelectric positioning, biasing, detection, and servo-control means for displacing the microtip with respect to the object and bringing it to a distance from the object on the order of one nanometer, to have a tunnel current flow between the microtip and the object, to measure the tunnel current, and to control, according to said measured tunnel current, the distance between the microtip and the object at a constant value; and second positioning and servo-control means capacitively coupled to the object to counter an attractive force between the object and the microtip according to said measured tunnel current, the second means being linked to a reference plane.

According to an embodiment of the present invention, the first piezoelectric positioning means comprise not only means for a positioning in the direction from the tip to the object, but also means for a positioning in a plane orthogonal to this direction.

According to an embodiment of the present invention, the object, together with the reference plane, is assembled on an x-y stage mobile with respect to the microtip.

According to an embodiment of the present invention, the object corresponds to an end area of a microcantilever.

According to an embodiment of the present invention, the device further comprises third means for setting the distance between the first means and the reference plane and thus the distance between the object and the reference plane.

### BRIEF DESCRIPTION OF THE DRAWINGS

The foregoing and other objects, features, and advantages of the present invention will be discussed in detail in the following non-limiting description of specific embodiments in connection with the accompanying drawings:

FIG. 1 is a diagram partially in the form of blocks illustrating an example of application of a system according to the present invention; and

FIG. 2 is a block diagram of a control circuit usable in the context of the present invention.

### DETAILED DESCRIPTION

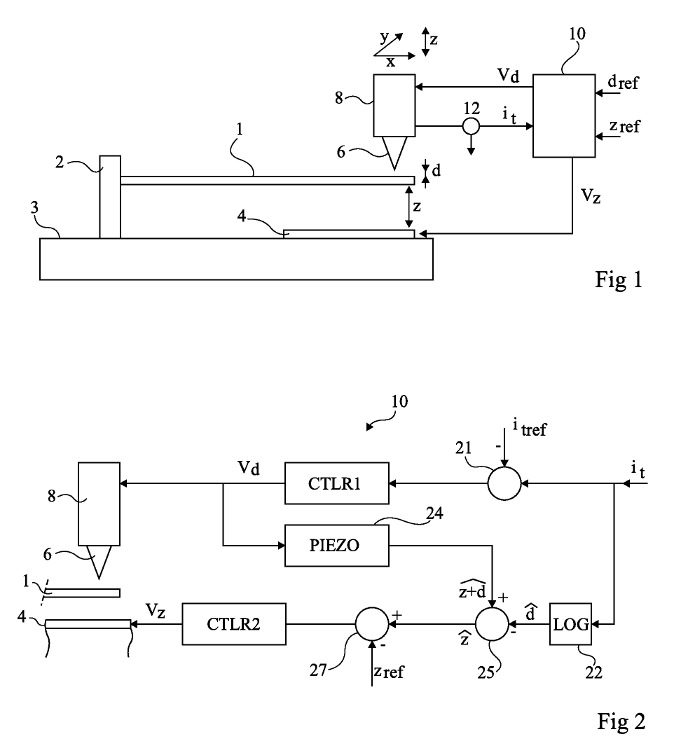

In FIG. 1, the shown dimensions do not correspond to the real dimensions, the diagram being provided for illustration purposes only. Indeed, some of the dimensions considered herein are on the order of one nanometer and others are on the order of one micrometer or one millimeter.

In an example of application of the present invention, the moveable object of very low inertia is considered to be the end of a mobile cantilever manufactured by MEMS technologies (intended to form microelectromechanical structures), for example using silicon etch techniques developed in the context of the manufacturing of integrated circuits on silicon.

Cantilevers having sufficiently small dimensions for their end to be able to be moved by a distance on the order of one nanometer, for example, from 1 to 50 nm, within a very short time, for example, shorter than one microsecond, are considered.

As illustrated in FIG. 1, a moveable cantilever 1 is fixed in a support 2 linked to a base 3 defining a reference plane. The cantilever is made of a conductive material or is coated with a conductive material and may be connected to a reference potential, for example, the ground, via support 2 in a way not shown. An electrode 4 capable of capacitively interacting with cantilever 1 is arranged on reference plane 3. A microtip 6 mounted on a block 8 is arranged on the other side of cantilever 1. The distance from a considered point of the cantilever to the reference plane will be called z and the distance from this point of the cantilever to the microtip will be called d.

Cantilever or microcantilever 1 for example has a length on the order of some hundred micrometers, for example from 50 to 300 μm, or more, and at least one dimension in the plane orthogonal to its length direction on the order of one tenth of a micrometer, or less, for example ranging between 50 and 200 nm. Such a microcantilever is likely to oscillate at frequencies of some tens or hundreds of kilohertz, while the displacement amplitude around its end is greater than one nanometer.

Block 8 comprises means for positioning the microtip in direction z, such positioning means for example being a piezoelectric crystal. Block 8 also comprises biasing means capable of connecting the microtip to a desired control potential Vd. A servo-control system 10 is connected to block 8. Servo-control system 10 receives information relative to tunnel current iₜ flowing from microtip 6 to cantilever 1. This current is provided by any adapted current detection sensor 12. Servo-control block 10 is capable of providing, on the one hand, a bias voltage Vd to microtip 6, and on the other hand, a bias voltage Vz to capacitive electrode 4. Servo-control block 10 further receives information relative to the distance d_{ref} which is desired to be maintained between the microtip and the object, and to the distance z_{ref} which is desired to be maintained between the object and the reference plane. In most applications, distance d_{ref} will be maintained constant. In some applications, it may be desired to vary this distance according to a determined rule, for example, to identify the transfer function of the mobile object or of any element of the control system. Generally, distance d_{ref} may be controlled in any known fashion.

Various servo-control circuits and systems are known to control distances according to set values (here, d_{ref} and z_{ref}) and to an error signal (here, the difference between measured tunnel current iₜ and a set value i_{tref}).

The inventors have observed that this double servo-control using, on the one hand, the actuation of a piezoelectric crystal to set the position of the microtip relative to the object and to attract the object towards the microtip (under the effect of proximity forces, for example, electrostatic forces or Van der Waals forces), on the other hand, a capacitive force to counter the attraction between the microtip and the object enables to obtain an extremely fast feedback system. Sufficiently fast circuits must of course be selected for control system 10. The distance between the microtip and the object can thus be maintained constant, while avoiding any sticking of the object to the microtip.

The present invention is likely to have many alternative embodiments and adapts to many applications.

In the case where the mobile object is a microcantilever as described previously, the present invention may be used to set the position of the microcantilever. For this purpose, it will be sufficient to adjust set value z_{ref} and to modify the D.C. voltage applied to the piezoelectric element to which the microtip is attached. When it is started from an initial value of z_{ref} and this value is then modified, the end of the microtip will displace accordingly, the servo-control system remaining set.

The present invention may also be used to form an accelerometer to measure an acceleration acting on the cantilever. This may be achieved by measuring the servo-control signal which must be applied to the capacitive actuator to maintain the cantilever fixed despite the applied acceleration. The same principle may be used to perform a small-scale force measurement, and this could be considered as a new version of a near-field microscope.

According to another alternative application of the present invention, of microscopy type, still in the case of a microcantilever, the structure of the upper surface of the microcantilever or of a very small object laid on the upper surface may be determined. To achieve this, a possibility of displacement in directions x and y (parallel to the reference plane) of the microtip will be provided. When the latter is displaced in this plane, distance d remains constant and distance z is modified and provides an indication about the relief of the microcantilever. In this case, preferably, the piezoelectric microcantilever positioning means comprise not only means for a positioning in the direction from the tip to the object but also means for a positioning in a plane orthogonal to this direction.

Other applications may be envisaged, such as the positioning of a gold micro- or nanoshell displaced, for example, on a sufficiently isolating plane, by means of the provided actuation in one of the plane axes or, by extension, an operation of micro- or nanotweezer type.

As another variation of the present invention, it may be provided for the base on which is object is assembled to be linked to an x, y, z translation stage to slowly displace the object with respect to the microtip and select an approximate initial position.

The previously-described double servo-control loop enables, as indicated, to avoid any sticking of the object to the microtip even though the object has a very low inertia and its position is capable of varying very fast due to external phenomena such as thermal noise. However, the loop lock-in may be insufficiently fast to avoid any initial snap-on when the microtip is started to be brought close to the object while the object is submitted to an oscillation or to fast erratic motions. Thus, the system according to the present invention will be preferably used by first bringing the microtip close to a substantially fixed portion of the object, and by then displacing the object with respect to the microtip (or conversely) to have the microtip face the portion of the object which is desired to be analyzed. This displacement, when it has to be of relatively large amplitude, as in the case where the object is a cantilever and where the microtip is desired to be displaced from the restraint area to the cantilever end, may be achieved by means of the above-mentioned x, y translation stage.

FIG. 2 shows a block diagram of a possible embodiment of a control block 10. Control block 10:
receives the scanning tunneling current iₜ measured by sensor 12 of FIG. 1,
receives a set value i_{tref} which is a reference scanning tunneling current corresponding to a desired value d_{ref} of distance d,
receives a value z_{ref} which corresponds to the desired value of distance z,
provides piezoelectric element 8 with a control voltage Vd, and
provides capacitor plate 4 with a bias voltage Vz.

In a first subtractor 21, set value i_{tref} is subtracted from the measured tunnel current value iₜ. The result of the subtraction (error signal) is provided to a first controller CTLR1 which calculates according to selected rules a voltage Vd to be provided to piezoelectric element 8 supporting microtip 6. Current iₜ is also provided to a logarithm calculation device 22 which calculates estimated value d of distance d. Indeed, it is known that in a scanning tunneling system, the tunnel current is an exponential function of the distance between the objects between which this current flows. Voltage Vd applied by controller CTLR1 to piezoelectric element 8 is sent to a model 24 of this piezoelectric element. This model provides an estimate (z\hat{+}d) of the distance between the microtip and the reference plane. The estimated values (z\hat{+}d) and \hat{d} are subtracted in a subtractor 25, whereby an estimated value \hat{z} of distance z is obtained. A subtractor 27 subtracts from this value \hat{z} the value z_{ref} desired for height z and the resulting error signal is provided to a controller CTLR2 which provides the desired voltage Vz to capacitor plate 4.

Of course, the servo-control system described in relation with FIG. 2 is an example only of a possible servo-control system. Further, the various elements of this servo-control system may be achieved in hardware or software fashion and receive analog or digital signals.

1. A device for positioning a moveable object capable of moving over a distance on the order of one nanometer within a time shorter than or equal to one microsecond, comprising:
a microtip;
first piezoelectric positioning, biasing, detection, and servo-control means for displacing the microtip with respect to the object and bringing it to a distance from the object on the order of one nanometer, for having a tunnel current flow between the microtip and the object, for measuring the tunnel current, and for controlling, according to said measured tunnel current, the distance between the microtip and the object; and
second positioning and servo-control means capacitively coupled to counter an attractive force between the object and the microtip according to said measured tunnel current, the second means being linked to a reference plane.

2. The device of claim 1, wherein the distance between the microtip and the object is controlled to a constant value.

3. The device of claim 1, wherein the first piezoelectric positioning means comprise not only means for a positioning in the direction from the tip to the object, but also means for a positioning in a plane orthogonal to this direction.

4. The device of claim 1, wherein the object, together with the reference plane, is assembled on an x-y stage mobile with respect to the microtip.

5. The device of claim 1, wherein the object corresponds to an end area of a microcantilever.

6. The device of claim 1 further comprising third means for setting the distance between the first means and the reference plane and thus the distance between the object and the reference plane.
